(19) United States
(12) Patent Application Publication
(10) Pub. No.: US 2020/0389564 A1
(43) Pub. Date: Dec. 10, 2020

(54) SYSTEM AND METHOD FOR AUGMENTED REALITY DEVICE MAINTENANCE

(71) Applicant: Toshiba TEC Kabushiki Kaisha, Shinagawa-ku (JP)

(72) Inventors: Marianne KODIMER, Lake Forest, CA (US); Louis ORMOND, Lake Forest, CA (US)

(21) Appl. No.: 16/433,518

(22) Filed: Jun. 6, 2019

(51) Int. Cl. H04N 1/00; G06K 9/62; G06K 9/00

(52) U.S. Cl. CPC H04N 1/00344; G06K 9/6201; H04N 2201/0094; H04N 1/00408; G06K 9/00671

(57) ABSTRACT

A system and method for an augmented reality device maintenance system includes a memory storing user instruction data corresponding to user actions to change a state of a multifunction peripheral. The user instruction data is stored associatively with state data corresponding to a known state of a multifunction peripheral. A processor stores digital image data from a captured image of the multifunction peripheral in the memory. A display generator generates an image corresponding to received image data on an associated display. The system also receives current device state data corresponding to a current operational state of the multifunction peripheral and retrieves, from the memory, user instruction data associated with state data that corresponds to received current device state data. The display generator superimposes instructions corresponding to retrieved user instruction data on the generated image.

### TECHNICAL FIELD

This application relates generally to assisted user device maintenance. The application relates more particularly to assisted end user maintenance of multifunction peripherals using a personal imaging device and augmented reality.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs are powerful, but complex devices which require regular maintenance. Device maintenance includes restocking of consumables, such as paper, toner or ink. Device maintenance further includes addressing simple issues, such as freeing paper jams. More complex device issues may require attention from a professional service technician.

### BRIEF DESCRIPTION OF THE DRAWINGS

Various embodiments will become better understood with regard to the following description, appended claims and accompanying drawings wherein:

FIG. 1 is an example embodiment of a device maintenance assistance system;

FIG. 2 is an example embodiment of a networked digital device;

FIG. 3 is an example embodiment of a portable digital device;

FIG. 4 is an example embodiment of an augmented reality device maintenance system;

FIG. 5 is an operational flowchart of operations of an example embodiment of augmented reality assisted device servicing;

FIG. 6 is an example embodiment of an augmented reality device maintenance operation image sequence;

FIG. 7 is an example embodiment of an augmented reality device maintenance assistance system;

FIG. 8 is an example embodiment of an augmented device maintenance assistance system employing audio or image input;

FIG. 9 is an example embodiment of user interaction with an augmented reality display; and

FIG. 10 is an example embodiment of an augmented reality device maintenance assistance system.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

When MFPs experience maintenance issues, it is advantageous when they can be addressed directly by end users. Issues treatable by end users result in minimized device down time, increased worker productivity and decreased worker frustration. There is a varying degree of difficulty within the category of user addressable maintenance issues. A new user will require assistance or training in handling even the simpler device issues. Certain device issues, such as problems that surface rarely or problems that require following a precise instruction sequence can be challenging to any user. If end user device maintenance is not done properly, it can result in further exacerbating the problem, and possibly damaging the device, perhaps to the point where a service call must be placed for a professional technician.

It is advantageous when more issues are addressable by end users over a wide range of device sophistication. User manuals may be complex, difficult to navigate or not readily available.

Example embodiments disclosed herein provide for assisting users perform device maintenance by use of a personal or portable imaging device, such as a smartphone, smart glasses, tablet computer or the like.

Embodiments detailed further below include an immersive instructional tool whereby the system presents an augmented reality animation in a step-by-step manner to be replicated or mimicked by an end user. This, used in conjunction with machine learning, provides a system that learns and improves recommended solutions over time.

The system suitably provides perceived reality of a system feed (visual and audio state or pattern) to be used in conjunction with error heuristics for problem solving. The system suitably provides “Perceived Reality” whereby an application can ascertain visual and audio anomalies of the system, as read by a feed obtained through the mobile device or wearable, to be used in conjunction with known heuristics about the system to suggest a hardware fix of the target device. As a result, the system can help the user trouble shoot hardware problems and prevent calls to service technicians.

In an example embodiment, an augmented reality device maintenance system includes a memory storing user instruction data corresponding to user actions to change a state of a multifunction peripheral. The instruction data is stored associatively with state data corresponding to a known state of a multifunction peripheral. A processor stores digital image data from a captured image of the multifunction peripheral in the memory. A display generator generates an image corresponding to received image data on an associated display. The system also receives current device state data corresponding to a current operational state of the MFP and retrieves, from the memory, user instruction data associated with state data that corresponds to received current device state data. The display generator superimposes instructions corresponding to retrieved user instruction data on the generated image.

In other example embodiments disclosed herein the system employs an imaging device, such as a smartphone, tablet or smart glasses that feeds audio and visual patterns to the system which determines whether the device state is indirectly or directly contributing to the reported problem in addition to simply fixing the reported problem.

In other example embodiments disclosed herein, augmented reality (AR) technology is used in conjunction with a digital imaging device such as a smartphone, tablet or smart glasses to provide digital information onto the physical world.

In other example embodiments, augmented reality, or AR, provides an immersive instructional tool whereby the system presents an augmented reality animation in a step-by-step manner to be replicated or mimicked by the end user. This will help users save money and time with DIY (do it yourself) tasks such as fixing the washing machine or office tasks, such as fixing a paper jam.

Example embodiments provide a system based on a conversation between the user and system where the task is broken down into steps, and each step is demonstrated on top of the real-world system using AR animation. The user then mimics the task on the real-world device. The hardware detects the device state, such as machine codes, device appearance, device sounds, or the like, which are triggered in response to user interaction and the state of which is communicated to the application to return a success, failure or not-attempted status. A successful step is suitably met with confirmation and presentation of a subsequent step. A failed step is suitably met with a confirmation and presentation of previous step and an additional hint. A not-attempted status is suitably met with a prompt.

Provision of an AR immersive instructional tool based on a demonstration and mimic feedback interaction will replace instructional videos for an unsophisticated or casual user and prove to reduce office service costs in the workplace.

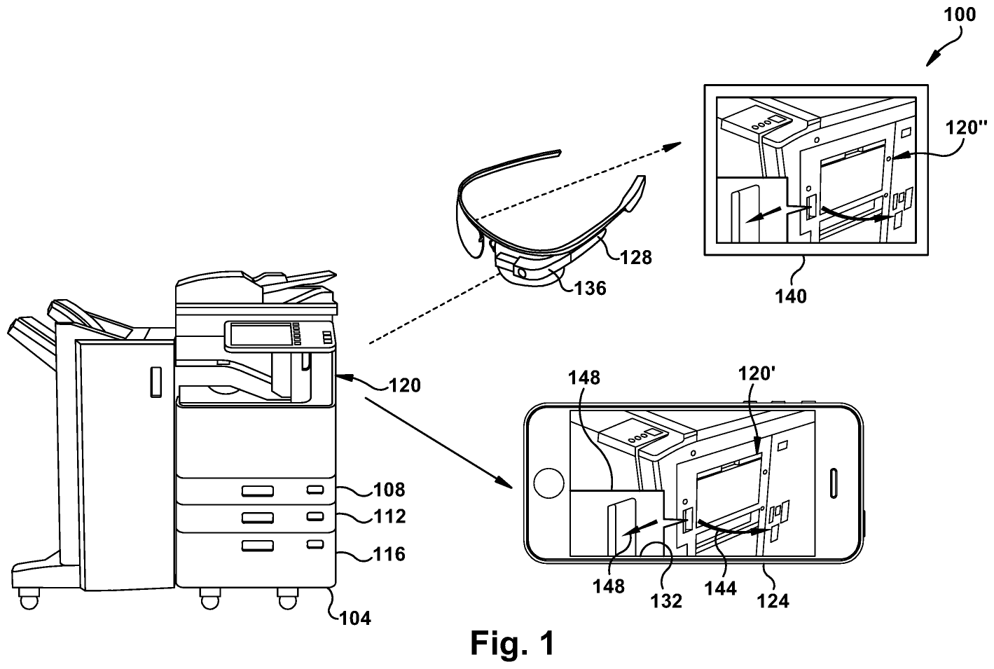

In accordance with the subject application, FIG. 1 illustrates an example embodiment of a device maintenance assistance system 100 associated with maintenance of an MFP 104. User addressable machine issues may comprise low consumable levels, with consumables such as paper, ink, toner or staples. Other examples of user-addressable MFP issues include cleaning out a hole punch dust bin, and dislodging paper jams. While any suitable maintenance operation is contemplated herein, the example embodiment of FIG. 1 is directed to paper jams. MFP 104 includes one or more paper trays, such as paper trays 108, 112 and 116, suitably comprising various paper sizes, and a paper bypass tray located generally at 120. Paper trays are example areas frequently associated with paper jams. A state of MFP 104 is suitably determined by device codes, device appearance, device sounds or user input.

Also illustrated in FIG. 1 are example personal or portable imaging devices including smartphone 124 and smart glasses 128, both of which incorporate digital cameras and display. Cameras of smartphone 124 and smart glasses 128 are directed to the bypass tray 120. On smartphone 124, display 132 displays an image 120′ of the bypass tray 120 of MFP 104. Similarly, on smart glasses 128, display 140 displays an image 120″ of bypass tray 120 of MFP 104. A processor on MFP 104 or a processor on a portable imaging device analyzes a captured image comprised of digital image data, such as an image capture by a camera 136 of smart glasses 128. The image portion under view is suitably subject to pattern matching from images of known MFP device exterior locations. A user may suitably pan over an MFP exterior to determine an area of concern which generates an indicator when a problem area has been detected. Alternatively, the processor is already made aware of an existing problem area and an overlay directs the user to point their camera on a specific area of the MFP. A captured image is suitably provided with one or more overlays, such as directional arrows 144 or 148, to assist them in addressing a device issue. Other suitable overlays will be detailed further below.

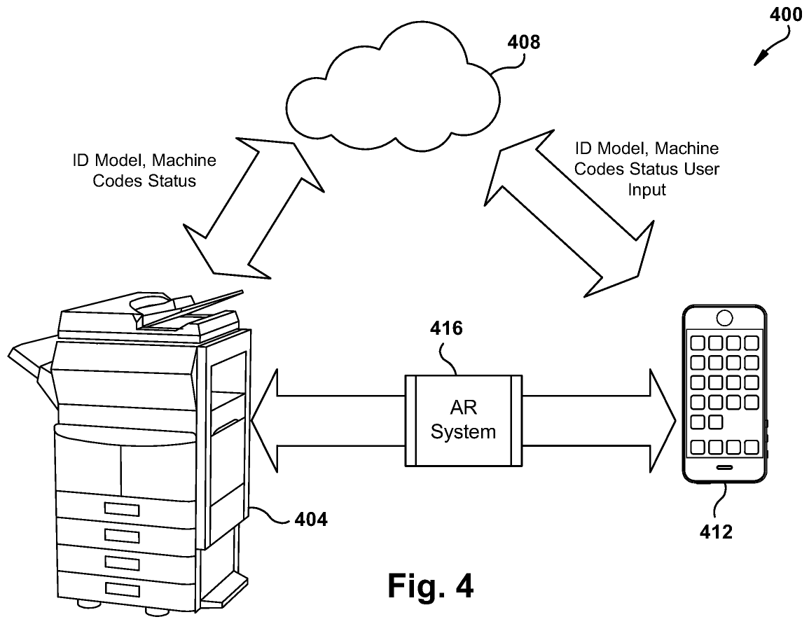

To accomplish the forgoing, the user's device suitably communicates with an intelligent device, such as networked server on which is stored MFP images, including images from different external perspectives. For example, see augmented reality device maintenance system 400 of FIG. 4. Stored images may be to all or some of an MFPs exterior, as well as images directed to particular components, including specific components, such as paper trays or sheet feeders. Stored images may also include internal images, such as images of the MFP when one or more access doors are open revealing internal device components, including component assemblies. Stored images are suitably linked associatively with user instructions, stored as user instruction data, which corresponds to one or more parts. When a user captured image is received, image pattern matching isolates one or more instructions associated with imaged parts. A state of the MFP is also captured. MFP states, suitably stored as device state data, include many monitored factors, including paper levels, ink or toner levels, device error codes indicative of problematic components or settings. A captured device state is also associated with imaged parts. Thus, if the MFP has a problem as indicated by error codes, the user can be directed with corresponding instructions, suitably delivered to their device as an image overlay superimposed on the captured image, instructing the user what to do relative to a user serviceable part. Such instruction may be graphical, such as by illustrating what the user should do or with an arrow directing the user. Instructions may also comprise character information, such as written instructions, alone or in combination with graphical instructions. A device state is suitably rechecked after a user has had an opportunity to act on received instructions to determine acceptability of an updated device state as indicated by updated device data. The new device state may instruct the user that a problem has been alleviated. It may also issue the user another instruction for action based on the new device state.

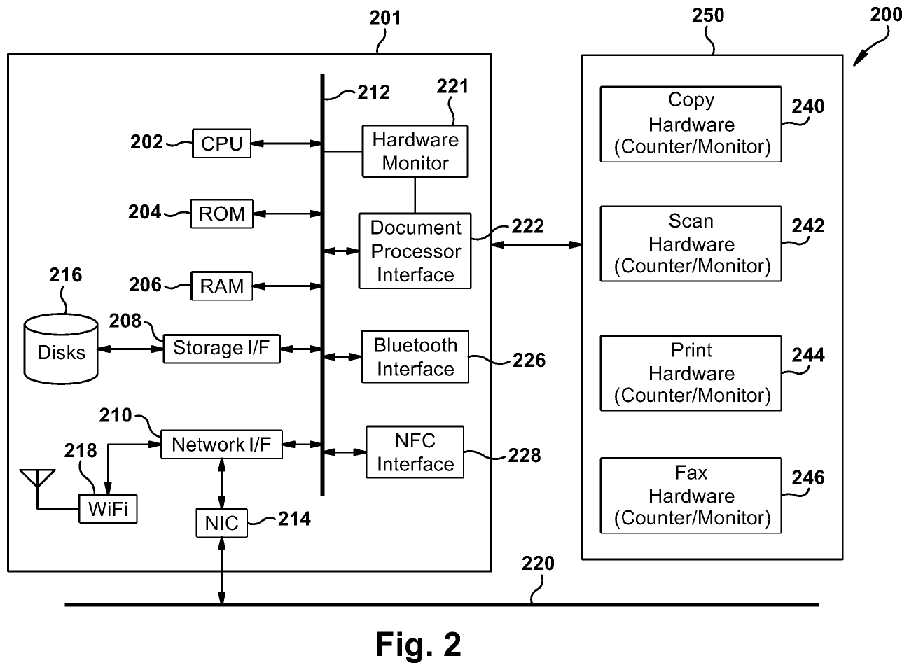

Turning now to FIG. 2 illustrated is an example embodiment of a networked digital device comprised of document rendering system 200 suitably comprised within an MFP, such as with MFP 104 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication a document processor interface 222, with BLUETOOTH interface 226 and NFC interface 228, either directly as shown via data path 212.

Processor 202 can also be in data communication with any suitable user input/output (I/O) interface (not shown) which provides data communication with user peripherals, such as displays, keyboards, mice, track balls, touch screens, or the like. As referenced above, hardware monitor 221 suitably provides device event or state data, working in concert with suitable monitoring systems. By way of further example, monitoring systems may include page counters, sensor output, such as consumable level sensors, temperature sensors, power quality sensors, device error sensors, door open sensors, and the like. Data is suitably stored in one or more device logs, suitably as device state data, in storage 216.

Document processor interface 222 is suitable for data communication with MFP functional units 250. In the illustrated example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

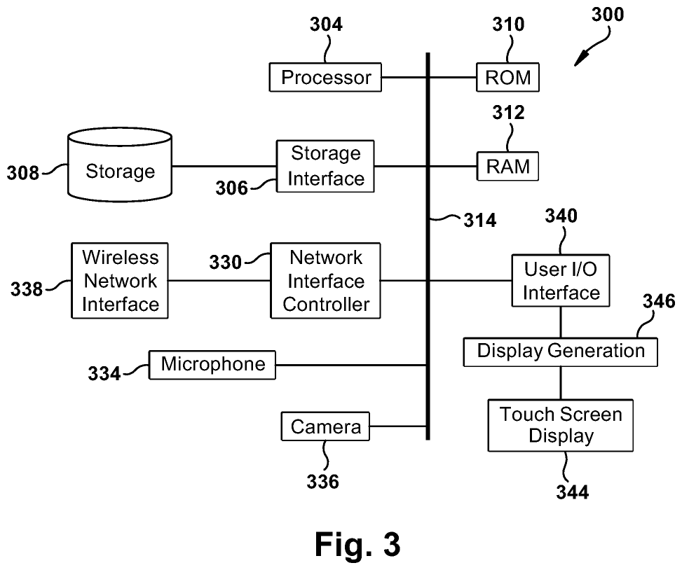

Turning now to FIG. 3, illustrated is an example of a portable digital device system 300 suitably comprising portable data devices such as smartphone 124 or smart glasses 128 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide area network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, or the like. Peripherals can also be connected via the data bus 314, such as camera 336 and microphone 334. It will be understood that functional units are suitably comprised of intelligent units, including any suitable hardware or software platform.

FIG. 4 illustrates an example embodiment of an augmented reality device maintenance system 400 for MFP 404. MFP 404 suitably communicates information about its state to a cloud server associated with network cloud 408. Example state data includes device ID, machine status codes, including error codes, measured results, such as device temperature, copy counts or consumable levels, or any other suitable device state information. Some or all device state data is suitably shared with a data device, such as smartphone 412. An augmented reality service 416 is operable to provide visual instructions to smartphone 412 to assist a user in connection with servicing MFP 404. Any suitable augmented reality service may be employed, including, by way of example, Apple, Inc. offers its ARKit developer platform. Current iterations of the ARKit platform provide support for two-dimensional image detection that triggers an augmented reality experience.

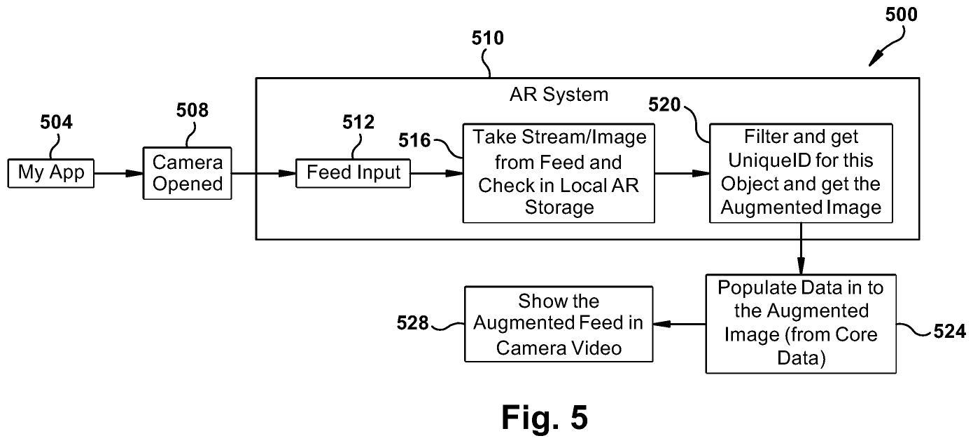

FIG. 5 is an operational flowchart 500 for operation of augmented reality assisted device servicing. A suitable portable imaging device application (app) is opened at block 504. This, in turn, enables an integrated camera at block 508. A captured digital image is fed into AR system 510 feed input block 512. A received image is checked against image data previously stored in memory at block 516, and such comparison returns a unique ID and associated image augmentation at block 520. Returned data is used to populate data in an augmented image, suitably from core data associated with the augmented image, at block 524. Next, an augmented image is displayed on a display integrated with the portable imaging device at block 528.

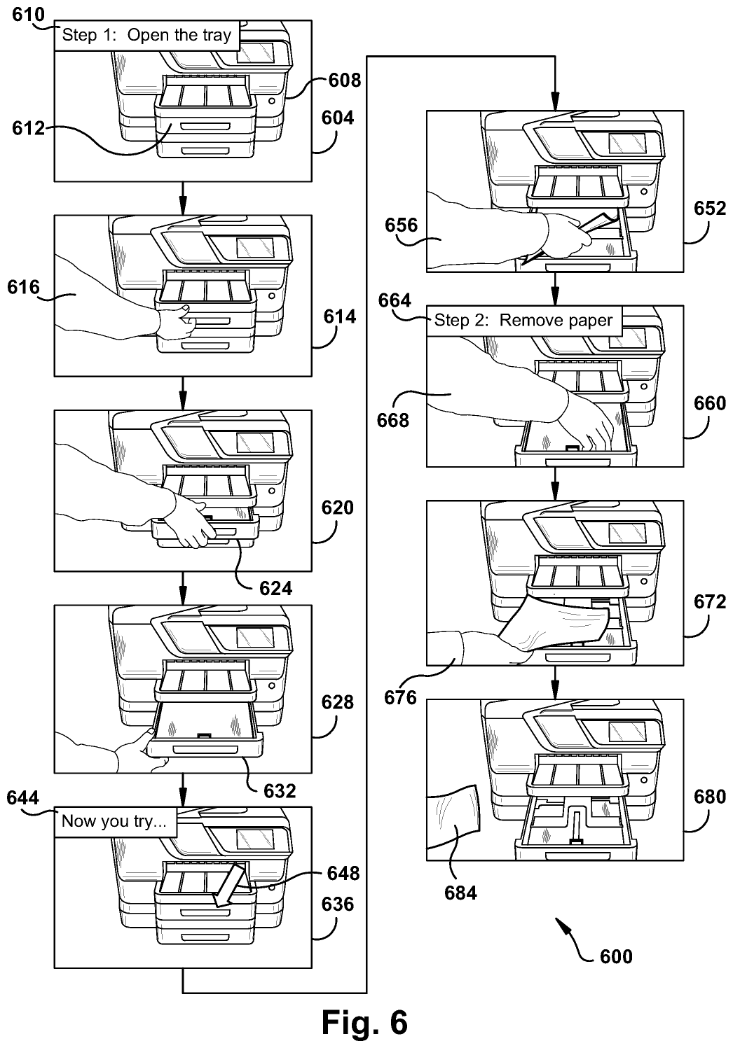

FIG. 6 is an example embodiment of an augmented reality device maintenance operation image sequence 600 as suitably viewed from a display integrated into a suitable portable image capture device. Example devices include smartphones, tablet computers or the like. Display 604 includes captured MFP image 608. The system determines one or more events associated with a detected object in the captured image, such as detection of the MFP. The system determines an action associated with a detected object and generates an overlay 610, such as the illustrated instruction to open a device paper tray 612 for paper removal.

Display 614 includes an augmented display of the MFP, along with a superimposed image 616 instructing the user where to position their hand to remove the tray. Next, display 620 includes a superimposed image 624 showing a tray grasp. Next, display 628 includes a superimposed image 632 demonstrating tray removal. Next, display 636 illustrates simultaneous overlays comprising an instructional text box 644 and a directional arrow 648 for tray opening.

Next, display 652 illustrates overlay 656 directing the user to remove paper from the paper tray. Display 660 then provides instructional text overlay 664 and graphical overlay 668 to instruct the user on how to grasp paper in the tray. Next, display 672 instructs the user on removal of paper from the tray with overlay 676. Finally, display 680 illustrates paper 684 removed from the paper tray.

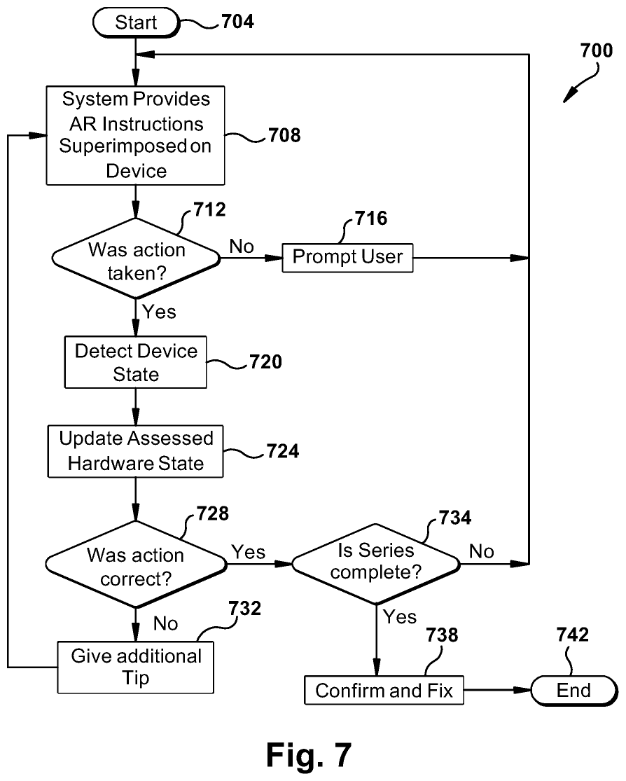

FIG. 7 is a flowchart 700 of an example embodiment of an augmented reality device maintenance assistance system. The process commences at block 704 and proceeds to block 708 where the system provides an augmented reality instruction superimposed on an image of a device on a display. A test is made at block 712 to determine whether the displayed instruction was completed. If not, the user is so prompted at block 716 and the system returns to block 708 where the instruction is displayed. If an action was taken, a current state of the device is detected at block 720. A hardware state is updated at block 724, and a determination is made at block 728 whether the action was correct, as evidenced by the updated hardware state. If not, an additional tip is displayed at block 732 and the process returns to block 708. If it is determined at block 728 that the action was correct, a determination is made at block 734 as to whether one or more instructions remain. If a series is not complete, the process returns to block 708 and a next instruction in a sequence is displayed. If no other instructions remain, progress is made to block 738 where confirmation is suitably made, such as with another check of the device's state, and any further fixes that might be accomplished are done. The process then ends at block 742.

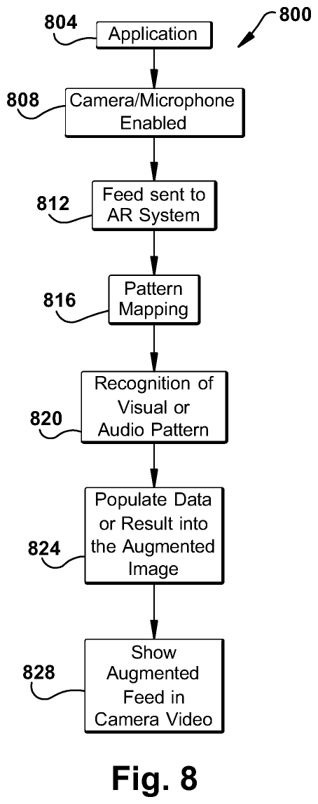

FIG. 8 is an operational flowchart 800 of an example embodiment of an augmented device maintenance assistance system employing audio or image input. A device application is launched at block 804 and an associated digital camera and/or digital microphone are enabled at block 808. Example audible input may be derived from device operation, such as sounds made during a scanning, copying of printing operation. Other example sounds may include sounds of removing a paper tray, plugging in a toner cartridge, or any other device operation that has a sound associated with it. As with recognition of objects or components in an image, sound patterns can be used and compared with known sound patterns.

Next, captured digital audio and/or video is sent to an augmented reality system at block 812, and pattern mapping with captured data and stored image or sound data is completed at block 816. Mapped data provides for recognition of visual or audio patterns at block 820. An associated augmented reality image is generated at block 824 and displayed at block 828 on an associated display. In this example embodiment, the system suitably diagnoses a device's condition from a capture image and/or audio.

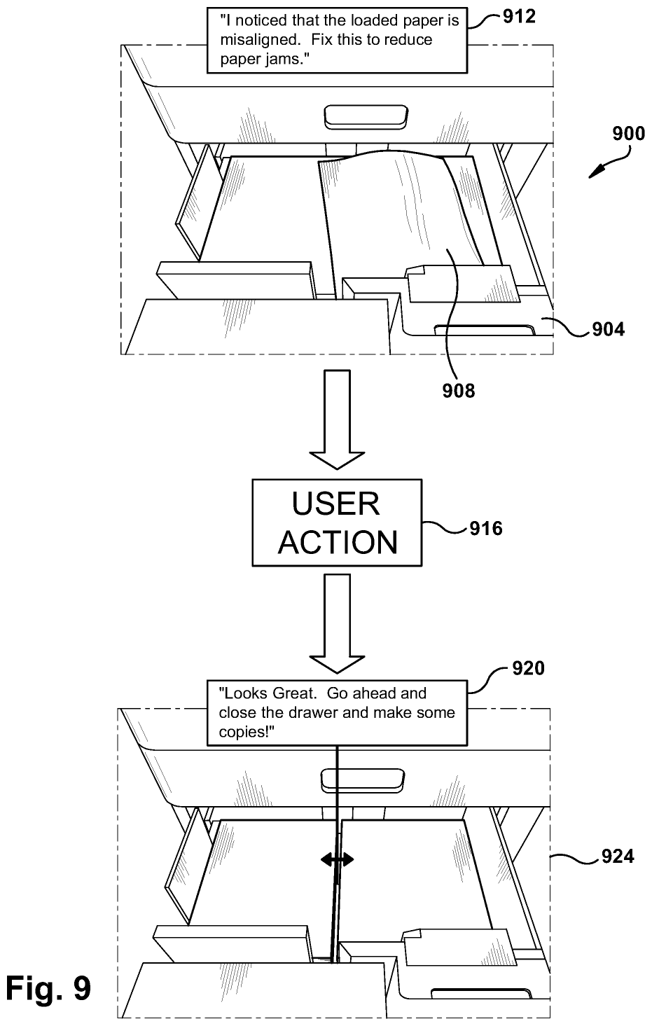

FIG. 9 illustrates an example embodiment of user interaction 900 with an augmented reality display. Display 904 is generated by an image captured by an imaging device, such as a smartphone. Pattern mapping relative to paper area 908 reveals misaligned paper. An instructional overlay 912 instructs a user as to what should be done to alleviate the problem. Thus, the example embodiment suitably diagnoses a problem autonomously and directs the user to a solution. A user, acting on the instruction overlay 912, performs an associate action at block 916, suitably with ongoing imaging or audio capture, or with a second capture session after the activity has been completed. The system determines that the problem was alleviated and generates an associated instructional overlay 920 on display 924.

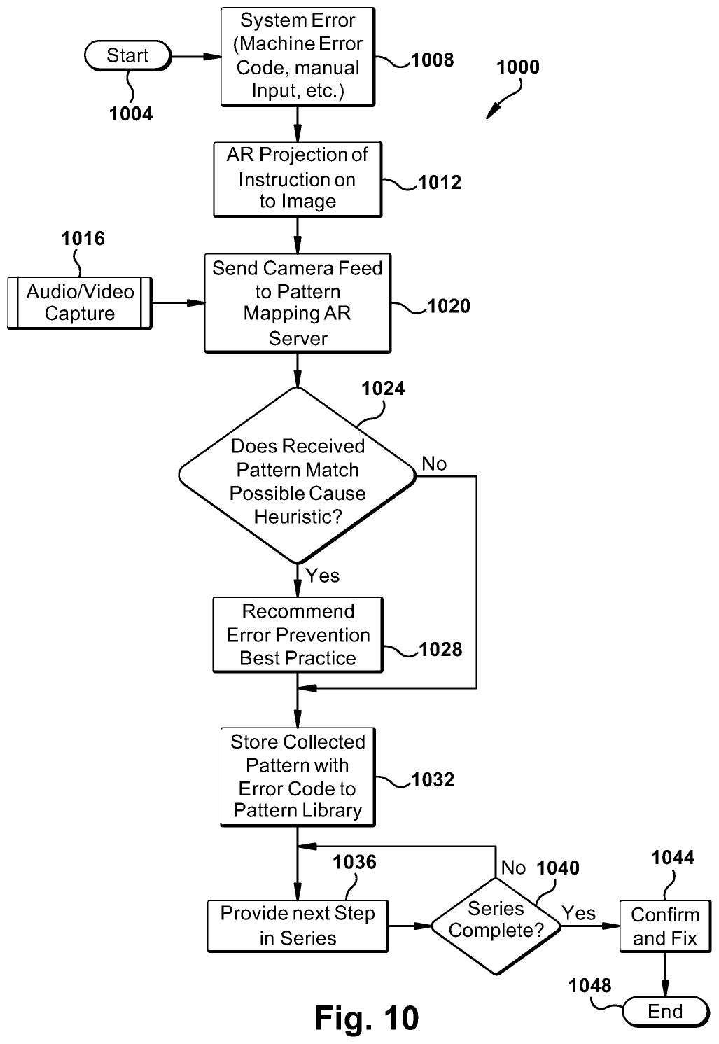

FIG. 10 is a flowchart 1000 of an example embodiment of an augmented reality device maintenance assistance system. The process commences at block 1004 and proceeds to block 1008 wherein data associated with a devices state is obtained. An associated instruction is determined and an associated image overlay is determined at block 1012. Such overlay, along with audio and/or video image data captured at block 1016 is sent to an augmented reality server at block 1020. Next, a determination is made at block 1024 as to whether captured data has an associated match from data previously stored, such as by determination of a possible cause heuristic. If a match is made, the process moves to block 1028 and a recommendation of an associated user action or actions is provided, such as by textual or graphic display or verbal output. The collected pattern and associated machine state, including such as might be determined by device error codes, are stored associatively in a pattern library at block 1032, and become available for future use. If no pattern match is made at block 1024, block 1028 is bypassed and the process moves directly to block 1032.

Next, any additional action step that may be desired are relayed to the user at block 1036, and determination is made if additional steps are required at block 1040. If so, the process returns to block 1036. If not, final confirmation and any fixes are applied at block 1044, and the process ends at block 1048.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a memory storing user instruction data corresponding to user actions to change a state of a multifunction peripheral, the user instruction data stored associatively with state data corresponding to a known state of the multifunction peripheral;
a data input configured to receive a perceived reality data including a current captured image of the multifunction peripheral and current audio information, from an associated portable data device;
a processor configured to store received perceived reality data in the memory; and
a display generator configured to generate an image corresponding to received image data on an associated display,
wherein the processor is further configured to receive current device state data corresponding to a current operational state of the multifunction peripheral,
wherein the processor is further configured to retrieve, from the memory, user instruction data associated with the perceived reality data and the state data, and
wherein the display generator is further configured to superimpose instructions corresponding to retrieved user instruction data on the generated image.

2. The system of claim 1 wherein the current device data is comprised of error codes generated from a device error detected in the multifunction peripheral.

3. The system of claim 1 wherein the processor is further configured to generate the current device data from the digital image data.

4. The system of claim 3 wherein the processor is further configured to generate the current device data from the digital image data by pattern matching with the state data.

5. The system of claim 1 wherein the processor is further configured to receive updated current device data after a display of the generated image with superimposed instructions.

6. The system of claim 5 wherein the processor is further configured to determine acceptability of the updated current device data.

7. The system of claim 6 wherein the display generator is further configured to generate an updated image on the associated display based on a determined acceptability of the updated current device data.

8. The system of claim 7 wherein the updated image comprises updated superimposed instructions.

9. A method comprising:
storing, in a memory, user instruction data corresponding to user actions to change a state of a multifunction peripheral, the instruction data stored associatively with state data corresponding to a known state of the multifunction peripheral;
receiving, from an associated portable data device, perceived reality data including a current captured image of the multifunction peripheral and current audio information of the multifunction peripheral;
storing received perceived reality data in the memory;
generating an image corresponding to received digital image data on an associated display;
receiving current device state data corresponding to a current operational state of the multifunction peripheral;
retrieving, from the memory, user instruction data associated with the perceived reality data and the state data; and
superimposing instructions corresponding to retrieved user instruction data on the generated image.

10. The method of claim 9 wherein the current device data is comprised of error codes generated from a device error detected in the multifunction peripheral.

11. The method of claim 9 further comprising generating the current device data from the digital image data.

12. The method of claim 11 further comprising generating the current device data from the digital image data by pattern matching with the state data.

13. The method of claim 9 further comprising receiving updated current device data after a display of the generated image with superimposed instructions.

14. The method of claim 13 further comprising determining acceptability of the updated current device data.

15. The method of claim 14 further comprising generating an updated image on the associated display based on a determined acceptability of the updated current device data.

16. The method of claim 15 wherein the updated image comprises updated superimposed instructions.

17. A device comprising:
a digital camera configured to capture an image of a multifunction peripheral;
an audio input configured to capture current audio input from the multifunction peripheral;
a display configured to display a captured image of the multifunction peripheral, the captured image including an image of a user serviceable part of the multifunction peripheral;
a memory configured to store image data corresponding to the captured image;
a wireless data interface; and
a processor configured to communicate the image data and the audio input to a networked data device via the wireless data interface,
wherein the processor is further configured to receive image overlay data, responsive to communicated image data and audio input, from the networked data device via the wireless data interface, and
wherein the processor is further configured to generate an overlay an image from the image overlay data on the captured image over the displayed captured image so as to display a user instruction for servicing of the user serviceable part.

18. The device of claim 17 wherein the digital camera is further configured to capture a second image of the multifunction peripheral including an updated image of the user serviceable part, wherein the second image is captured after display of the user instruction,
wherein the processor is further configured to communicate second image data to the networked data device via the wireless data interface,
wherein the processor is further configured to receive updated instruction data responsive to the communicated second image data via the wireless data interface, and
wherein the processor is further configured to generate a revised display image on the display corresponding to received updated instruction data.

19. The device of claim 18 wherein the revised display image includes a second user instruction indicative of successful activity performed by the user on the user serviceable part.

20. The device of claim 18 wherein the revised display image includes a second user instruction indicative of activity to be performed by the user on the multifunction peripheral.
